(19) United States
(12) Patent Application Publication
(10) Pub. No.: US 2017/0373382 A1
(43) Pub. Date: Dec. 28, 2017

(54) WIFI ANTENNA OF THE CLOVER-LEAF OR SKEW-PLANAR WHEEL TYPE FOR A DRONE

(71) Applicant: PARROT DRONES, Paris (FR)

(72) Inventor: Fabrice MAINGOT, Saint Maur des Fosses (FR)

(21) Appl. No.: 15/632,242

(22) Filed: Jun. 23, 2017

(30) Foreign Application Priority Data
Jun. 23, 2016 (FR) 1655839

(51) Int. Cl. H01Q 1/28; H01Q 1/22; H01Q 5/30; H01Q 7/00; H01Q 1/38

(52) U.S. Cl. CPC H01Q 1/28; H01Q 7/00; H01Q 1/38; H01Q 5/30; H01Q 1/2291; H01Q 1/287

(57) ABSTRACT

An antenna includes one or more elementary antennas with non-coplanar planar loops extending about a main axis in respective inclined planes. Each elementary antenna is formed by tracks of a structure printed on a circuit support extending in the inclined plane, with two imbricated planar loops tuned on frequencies includes in two respective distinct WiFi frequency bands. With a flexible circuit support, an antenna housing of the drone includes a conformed hollow cavity comprising a plurality of inclined planar faces, which are the counterparts of the inclined planes of the elementary antennas, against which bear these latter after deformation of the flexible support.

### CROSS REFERENCE TO RELATED APPLICATIONS

This application claims priority under 35 U.S.C. §119(a) to French Patent Application Serial Number 1655389, filed Jun. 23, 2016, the entire teachings of which are incorporated herein by reference.

### BACKGROUND OF THE INVENTION

### Field of the Invention

The invention relates to remote piloting of motorized devices, hereinafter generally referred to as “drones”, in particular flying drones, with rotary wing or fixed wing, and more precisely, to radiocommunication antennas used by these devices for the remote piloting thereof.

### Description of the Related Art

Typical examples of flying drones are the BEBOP™ of Parrot SA, Paris, France, which is a rotary-wing drone of the quadricopter type, or the DISCO™, also of Parrot SA, which a fixed-wing drone of the flying-wing type. Another type of drone to which the invention may apply is the JUMPING SUMO™, also of Parrot SA, which is a remote-controlled rolling and jumping toy.

Patent Cooperation Treaty Published Application WO 2010/061099 A2 and each of European Published Patent Applications EP 2 364 757 A1, EP 2 450 862 A1 and EP 2 613 213 A1 describe the principle of piloting a drone by means of a touch-screen multimedia telephone or tablet having integrated accelerometers, for example a smartphone or a tablet, executing a specific remote-control applicative software program such as, in the above-mentioned example, the mobile application FREEFLIGHT™ of Parrot SA.

This telephone or tablet may possibly be relayed by a specific remote-control device such as the SKYCONTROLLER™ of Parrot SA, which is a console interfaced with the telephone or the tablet in the form of a box provided with two handles with joysticks and various buttons for an ergonomic piloting by the user in the same way as a dedicated remote-control console. The device further comprises an emitter/receiver acting as a relay between the telephone, the tablet and the drone, the emitter being provided with an amplifier for increasing the power radiated to the radio channel used between the remote control and the drone. These aspects of the radio communication between console and drone are described, in particular, in the European Published Patent Applciation EP 3 020 460 A1.

Generally, a drone remote-control device incorporates the various control elements required for the detection of the drone piloting commands and for the bidirectional exchange of data via a radio link of the WiFi (IEEE 802.11) or Bluetooth wireless local network type directly established with the drone. This bidirectional radio link comprises a downlink (from the drone to the remote control) to transmit data frame containing a video stream coming from a camera on board the drone and flight data or state indicators of the drone, as well as an uplink (from the remote control to the drone) to transmit the piloting commands.

It will be understood that the quality of the radio link between the remote control and the drone is an essential parameter, in particular to ensure a satisfying range. Indeed, the volumes of data transmitted are significant, in particular due to the very high need in video bitrate of the downlink, so that any degradation of the quality of the radio link will have an impact on the quality of the transmission and on the radio range, with a risk of sporadic losses on the data and the commands exchanged.

At the drone, the radio link uses one or several antennas incorporated to the drone, which, in reception, pick up the signals emitted by the remote-control device and, in emission, radiate the power of the HF emitter circuit supporting the downlink, in particular for the transmission of the video flow and flight data signals.

Today, the drones generally use as WiFi antennas dipole-type antennas, in particular formed of two dipoles coupled to two respective antenna terminals of the WiFi radio chip.

This dipole-based structure of antenna has however for drawback a rather irregular radiation pattern, having in particular gain dips in the dipole axis.

Moreover, the dipoles produce by nature a linear polarization, which is not optimal in the case where the remote-control device implements antennas of the patch type that, by nature, are circularly polarized. This difference between the polarizations introduces in the link a gain loss of a few decibels, loss that further varies according to the relative orientation of the remote control and the drone.

Another type of antenna is known, called clover-leaf or skew-planar wheel, which is often used by the model aircraft lovers for the remote control of flying motorized devices.

The antenna is in the form of multiple loops, generally three in number (clover-leaf) or four in number (skew-planar wheel), extending in planes that are inclined with respect to the main axis of the antenna and with respect to a radial plane, and distributed circumferentially and symmetrically about this axis and remote from the latter. The ends of each loop are coupled together to a common coaxial power supply cable at a central point located in the lower part of the main axis of the antenna.

This very particular type of antenna is to be distinguished from those formed of an array of coplanar loops arranged above a floorplan, as the antennas disclosed for example in Published United States Patent Applications US 2012/056790 A1 or US 2011/063180 A1, which describe directive antennas, unsuited to the establishment of a stable radio link with a drone in motion.

Indeed, the clover-leaf or skew-planar wheel antenna has the very particular characteristic to provide a near-spherical radiation pattern, particularly advantageous in the case of the remote control of a flying device, because the orientation of the latter with respect to the pilot may vary very widely as a function of the movements of the device (turns, etc.), even more in case of acrobatic flight (spins, rolls, etc.).

Concretely, the clover-leaf or skew-planar wheel antennas are generally made from cupper wires or tubes bent in loops and hand welded, at their ends, to a central support allowing the orientation of the different loops between each other and with respect to the main axis of the antenna to be maintained.

They are however relatively fragile structures that are delicate to make (due to the non-coplanar geometry of the loops), and in any event incompatible with an industrial mass-production.

For that reason, this type of antenna is not used in the drones produced in mass production. Today, these latter implement dipole-type antennas for the WiFi, with the various drawbacks exposed hereinabove causing theses antennas based on dipole arrays to be less efficient than the antennas of the clover-leaf or skew-planar wheel type.

### SUMMARY OF THE INVENTION

A first object of the invention is to compensate for the drawbacks of the wire structure, which is that of the antennas of this particular clover-leaf or skew-planar wheel type proposed up to now, by proposing such an antenna that is adapted for a heavy industrial mass-production, minimizing the manual operations of manufacturing of the antenna itself and of mounting of the latter in the drone.

Another object of the invention is to design such an antenna structure whose reduced size allow it to be easily integrated into the thickness of the wings or the arms of a drone, without any protruding element that would increase the drag of the drone, and that does not represent a significant mass liable to needlessly make the drone heavier.

The matter is in particular to have an antenna structure typically adapted to the centimetric frequency bands such as the WiFi bands, which can be used instead of the dipoles used up to now, in order to provide a radiation pattern that is both extended and homogeneous in a very wide sector of the space.

To solve the above-mentioned problems, the invention proposes an antenna with a near-spherical radiation pattern, of the clover-leaf or skew planar wheel type, comprising, in manner known in itself: a plurality of elementary antennas with non-coplanar planar loops extending circumferentially and symmetrically about a main axis of the antenna and remote from this axis, in respective planes inclined with respect to the main axis, these inclined planes forming an angle with respect to a radial plane; and a module for the coupling and the adaptation of the elementary antennas to a coaxial cable for the power supply of the antenna.

Characteristically of the invention, each elementary antenna is formed by tracks of a structure printed on a circuit support extending in said respective inclined plane; and each elementary antenna comprises two imbricated planar loops, tuned on frequencies comprised in two respective distinct WiFi frequency bands.

According to various advantageous subsidiary characteristics:
the antenna has no conductive element extending in a radial plane and forming a mass plane;
the printed structure of each elementary antenna comprises: a first rectilinear track and a second rectilinear track that extend radially by forming an angle between each other from a central region of the antenna located in the vicinity of the coupling and adaptation module; and a first curved track and a second curved track that each extend circularly between the first rectilinear track and the second rectilinear track;
the first curved track is an external curved track extending between respective distal ends of the first and the second rectilinear track, and the second curved track is an internal curved track extending between respective median regions of the first and the second rectilinear tracks. The first curved track then forms with the first and second rectilinear track a loop tuned on a frequency located in a first WiFi band, whereas the second curved track forms with the first and second rectilinear track a loop tuned on a frequency located in a second WiFi band, different from the first WiFi band;
the second curved track is split into two tracks extending parallel to each other and forming two loops respectively tuned on two distinct frequencies of the second WiFi band;
the coupling and adaptation module comprises two terminals with a first terminal connecting the proximal ends of the first rectilinear tracks of the respective elementary antennas on one side of the support, and a second terminal connecting the proximal ends of the second rectilinear tracks of the respective elementary antennas, after passing through the support near said proximal ends;
the angle with respect to a radial plane of said inclined planes in which extend the non-coplanar loops is of at least 20° and at most 45°, and it is preferably comprised between 25° and 30°;
the circuit support is perforated in a zone comprised between the first and the second curved track and/or in a zone comprised between the second curved track and the proximal region of the elementary antenna.

In a first embodiment, the circuit support is a stiff circuit support made of an epoxy material.

In a second, particularly advantageous embodiment, the circuit support is a flexible circuit support, in particular a pre-notched support with a plurality of radial separating notches radiating between the elementary antennas from a central region of the antenna. The parts of the flexible circuit support located between the radial separating notches may then be each connected to the central region by a bridge of matter forming a hinge. The antenna may further comprise an additional layer of epoxy material deposited at the surface of the flexible circuit support on the side of the tracks of the printed structure.

The invention has also for object a drone comprising: a drone body from which extend laterally two wings and at least two arms, at least one antenna as hereinabove, and at least one antenna housing receiving said antenna.

The drone advantageously comprises two antennas arranged symmetrically on either side of the body and incorporated in the thickness of the body or of the wings of the drone.

In a particularly advantageous embodiment, when the circuit support of the elementary antennas is a flexible circuit support, the antenna housing comprises a conformed hollow cavity comprising a plurality of inclined planar faces, which are the counterparts of the respective inclined planes of the elementary antennas, and against which bear the elementary antennas after deformation of the flexible circuit support.

### BRIEF DESCRIPTION OF THE DRAWINGS

We will now describe an example of implementation of the present invention, with reference to the appended drawings in which the same references designate throughout the figures identical or functionally similar elements.

FIG. 1 is an overall view showing a drone moving in the air under the control of a distant remote-control device.

FIG. 2 is a perspective view of an antenna according to a first embodiment of the invention.

FIGS. 3 and 4 illustrate in a perspective view the detail of the central portion of the antenna of FIG. 2, viewed from above and from below, respectively.

FIG. 5 is a top view of an antenna according to a second embodiment of the invention.

FIG. 6 illustrates, in a perspective view from below, the antenna of FIG. 5.

FIG. 7 illustrates, in a perspective view from below, the detail of the central portion of the antenna of FIG. 6.

FIG. 8 illustrates the positioning of the antenna of FIGS. 5 to 7 in a drone housing including a hollow cavity permitting to provide the planes of the elementary antennas with their respective inclinations with respect to the central axis of the antenna.

FIG. 9 is a diagram showing the variation of the parameter S₁₁ describing the radioelectric behaviour of the antenna of the invention as a function of the emission/reception frequency.

### DETAILED DESCRIPTION

An exemplary embodiment of the antenna of the invention will now be described.

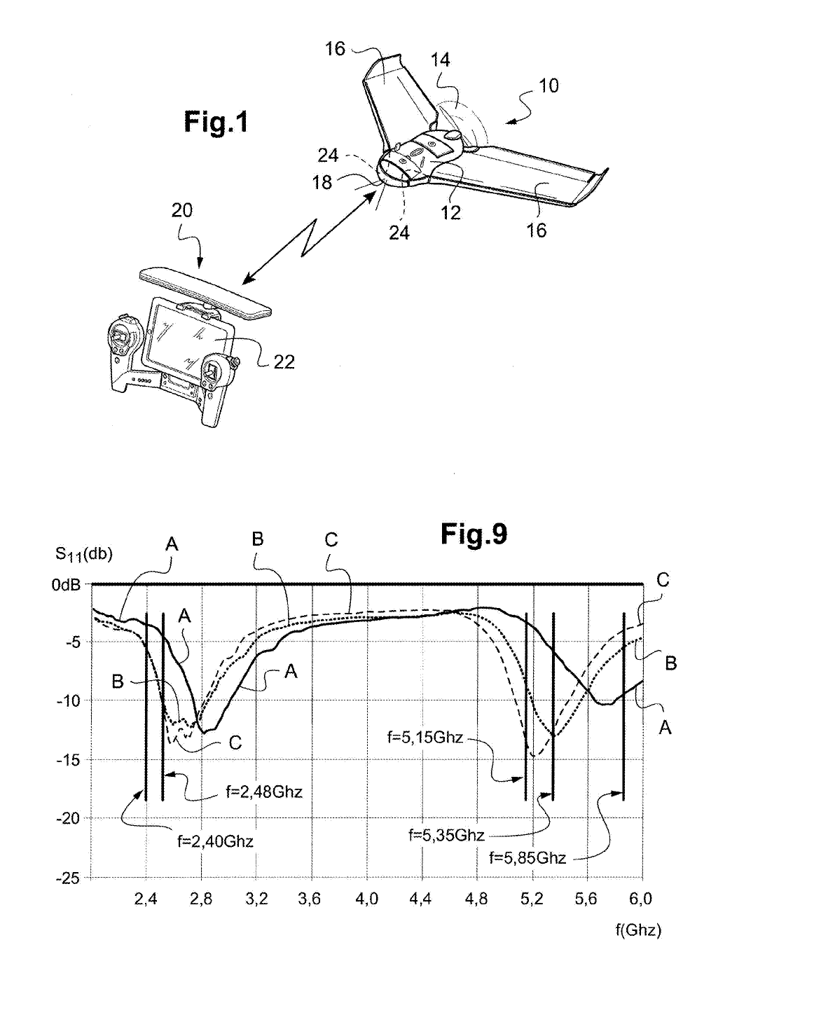

In FIG. 1 is illustrated a drone 10, for example a fixed-wing drone such as the DISCO™ of Parrot SA. This drone 10 comprises a fuselage 12 provided, on the rear portion, with a propeller 14, and laterally, with two wings 16, wherein these wings can possibly be integral with the fuselage 12 in a configuration of the “flying wing” type. A front camera 18 allows obtaining an image of the scene towards which the drone progresses.

The drone 10 is piloted by a distant remote-control apparatus 20 provided with a touch screen 22 displaying the image captured by the camera 18, as well as various piloting commands at the user's disposal. The remote-control apparatus 20 is provided with means for radio link with the drone, for example of the Wi-Fi (IEEE 802.11) local network type, for the bidirectional exchange of data from the drone 10 to the apparatus 20, in particular for the transmission of the image captured by the camera 18, and from the apparatus 20 to the drone 10 for the sending of piloting commands.

To ensure the communication with the remote-control apparatus 20, the drone is provided with a system of antennas, typically two antennas 24 arranged symmetrically on the front of the drone, on either side of the fuselage 12, and coupled to two respective inputs of the WiFi radio chip.

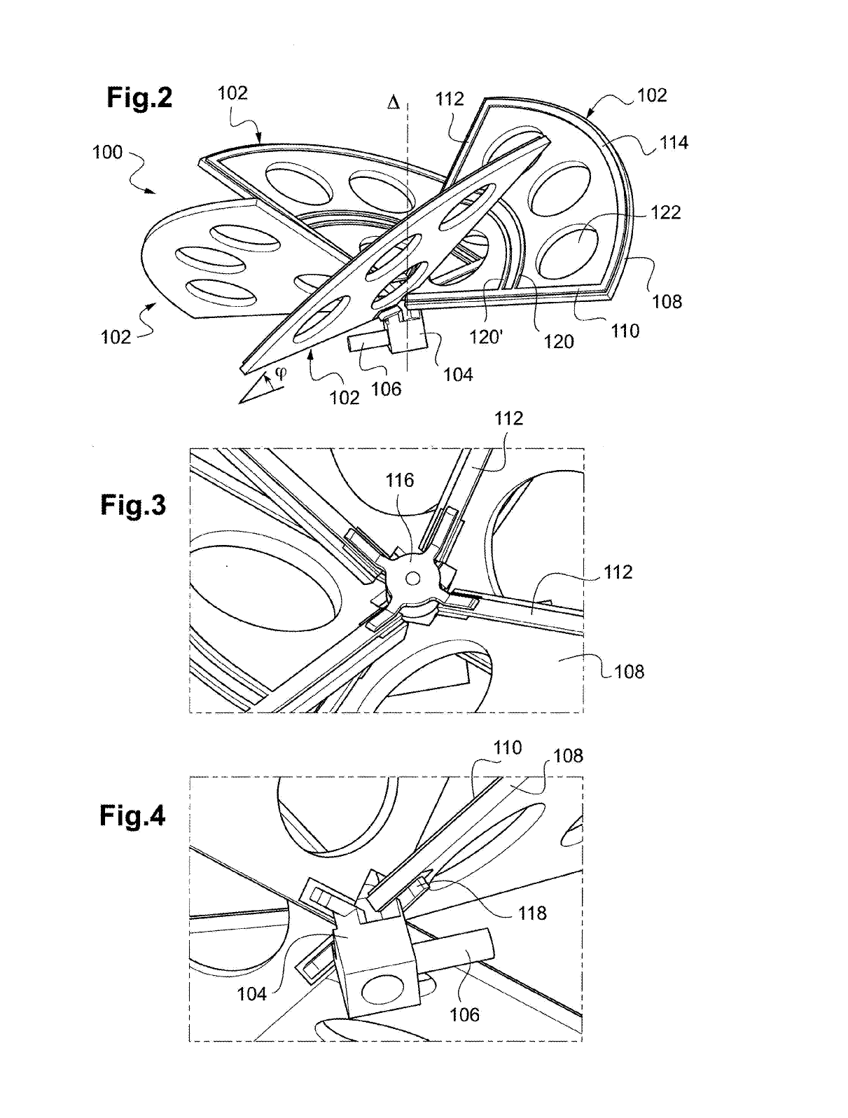

FIGS. 2 to 4 illustrate an example of a first embodiment of the antenna of the invention, which is an antenna particularly well adapted to centimetric frequency bands such as WiFi bands (2.40 GHz-2.4835 GHz and 5.15 GHz-5.85 GHz).

This application, although being particularly advantageous because responding to precise problems in particular in the field of antennas for drones, is however not limitative, and the configuration of antenna of the invention may be used in other fields, for other applications and in other frequency bands.

In FIGS. 2 to 4 is illustrated the antenna 100 of the invention, which is an antenna of the so-called clover-leaf or skew-planar wheel type, which comprises a plurality of elementary antennas 102, generally three in number (clover-leaf) or four in number (skew-planar wheel). Each elementary antenna 102 comprises a planar loop extending in a respective plane inclined with respect to the main axis Δ of the antenna, the different loops being non-coplanar and distributed circumferentially and symmetrically about this axis and remote from this axis Δ. In the example illustrated, the antenna 100 comprises four of these elementary antennas 102, but this number is in no way limitative, wherein an antenna according to the invention can comprise a lower, or a higher, number of such elementary antennas.

The angle of inclination φ is chosen and optimized (by measurement or simulation) as a function of the global radiation pattern that is desired for the antenna 100. This angle of inclination φ is typically of at least 20° and at most 45°; it is generally comprised between 25° and 30°, preferably of about 27°.

The loops of each of the elementary antennas 102 are coupled together to a common module 104 for the coupling and the adaptation to a coaxial power supply cable 106 connecting the antenna 100 to the emitter/receiver circuits of the radio chip of the drone.

Characteristically, each elementary antenna 102 is made by etching of a conductive surface of a printed circuit board (PCB), this etching forming a particular conductive pattern defining the radiating element of the elementary antenna, herein two planar loops tuned on frequencies corresponding to the two WiFi frequency bands used. This structure, which may be easily produced in industrial mass production, is repeated four times (for each of the four elementary antennas) with the same pattern, the whole being mounted on a common support allowing each of the four PCBs, i.e. each elementary antenna, to be provided with an accurate angle φ that allows obtaining the desired performance.

The support 108 of the PCB on which is etched the conductive pattern is, in this first embodiment, a stiff support, for example made of an epoxy material, cut as circular sectors of 90° opening, so as to give each elementary antenna a shape of a quarter of a circle.

The conductive pattern etched on the PCB comprises a first radial rectilinear track 110 extending along one of the radial edges of the circular sector, a second radial rectilinear track 112 extending along the opposite edge of the circular sector, and a first peripheral curvilinear track extending along the circular edge of the circular sector.

The three tracks 110, 112, 114 form a loop, tuned on the lower WiFi band (2.40 GHz-2.4835 GHz), which corresponds to a wavelength of about 35 mm for the radius of the circular sector forming the elementary antenna 102.

The four elementary antennas 102 are made identically so as to form four non-coplanar distinct loops. The second rectilinear tracks 112 are connected together (FIG. 3) at 116 in a central region of the antenna to a first terminal of the coupler 104, corresponding for example to the core of the coaxial power supply cable 106. The first rectilinear tracks 110 are, for their part, connected (FIG. 4) to a second terminal of the coupler 104, corresponding for example to the external conductor of the coaxial cable 106, via a bushing 118 formed through the PCB support 108.

Each elementary antenna 102 further comprises a second curvilinear track 120, of circular shape, extending between the first radial rectilinear track 110 and the second radial rectilinear track 112 in a median region of the support 108.

This second curvilinear track 120 forms with the first and second rectilinear tracks 110, 112 a second loop of lower size than the first resonating loop, this second loop being tuned to the upper WiFi band (5.15 GHz-5.85 GHz). The second curvilinear track may be possibly split, as illustrated in 120, 120′, in order to provide a wider bandwidth in the considered frequency band.

To reduce the mass of the antenna, the PCB support 108 may include several recesses 122 in the regions with no conductive track, i.e. between the curvilinear tracks 114 and 120 and/or between the curvilinear track 120 and the region located near the axis Δ.

From the radioelectric behaviour point of view, we hence have a clover-leaf or skew-planar wheel antenna able to operate simultaneously in the two WiFi frequency bands, with a circular polarization (right circular polarization RHCP) particularly well adapted to a piloting from a remote-control device implementing antennas of the patch type that, by nature, are circularly polarized, by minimizing the gain losses with respect to a conventional dipole antenna, and with a substantially constant gain whatever the relative orientation of the remote control and the drone.

The radiation pattern of an antenna such as that which has just been described is a near-spherical pattern, allowing the drone to communicate with the remote-control apparatus whatever the relative orientation of the remote control and the drone, which is in particular indispensable in acrobatic flight, where, at a given instant of time, the drone may take any orientation with respect to the ground and hence with respect to the remote control.

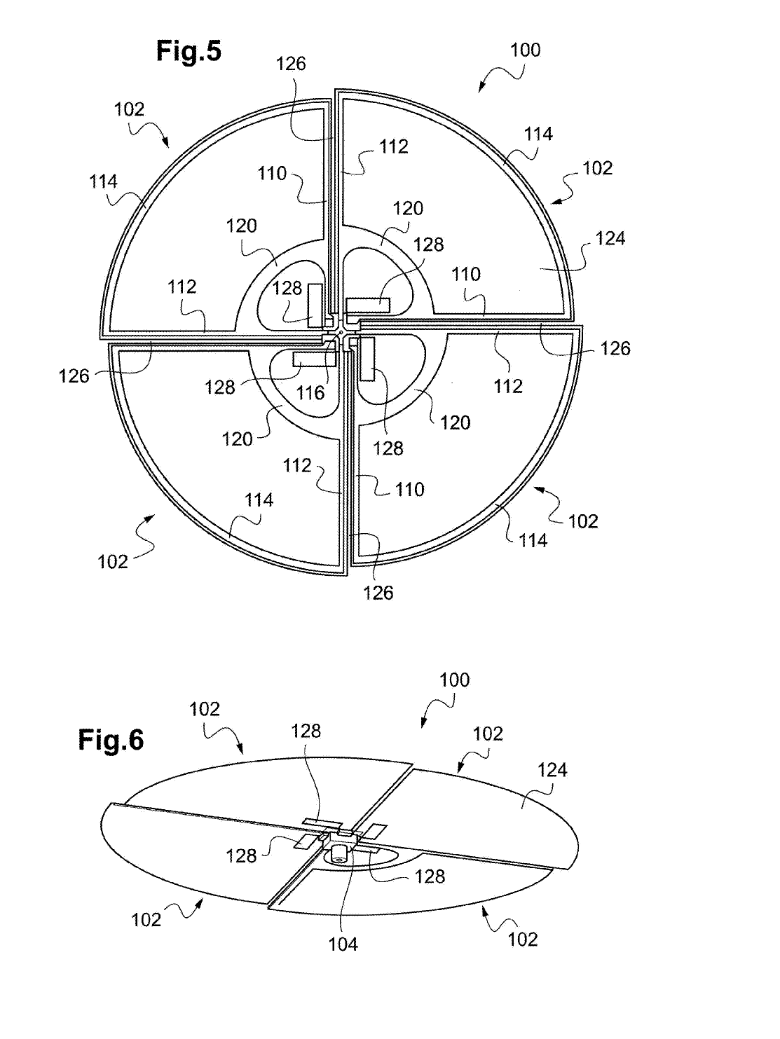

FIGS. 5 to 8 illustrate a second embodiment of the antenna of the invention, also adapted to a communication in the two WiFi frequency bands.

In these FIGS. 5 to 8, the same numerical references as those appearing in FIGS. 2 to 4 are used to denote functionally similar elements, which have already been described and which won't be described again.

In this second embodiment, the inclined structure of the conductive pattern defining the loops is formed on a flexible support 124 of the “flex PCB” type, typically made of polyimide.

This flexible support 124 has approximately the shape of a circular disc, in which have been formed radial notches 126 delimiting four circular sectors of 90° opening (a quarter of a circle), which define and individualize the four elementary antennas 102.

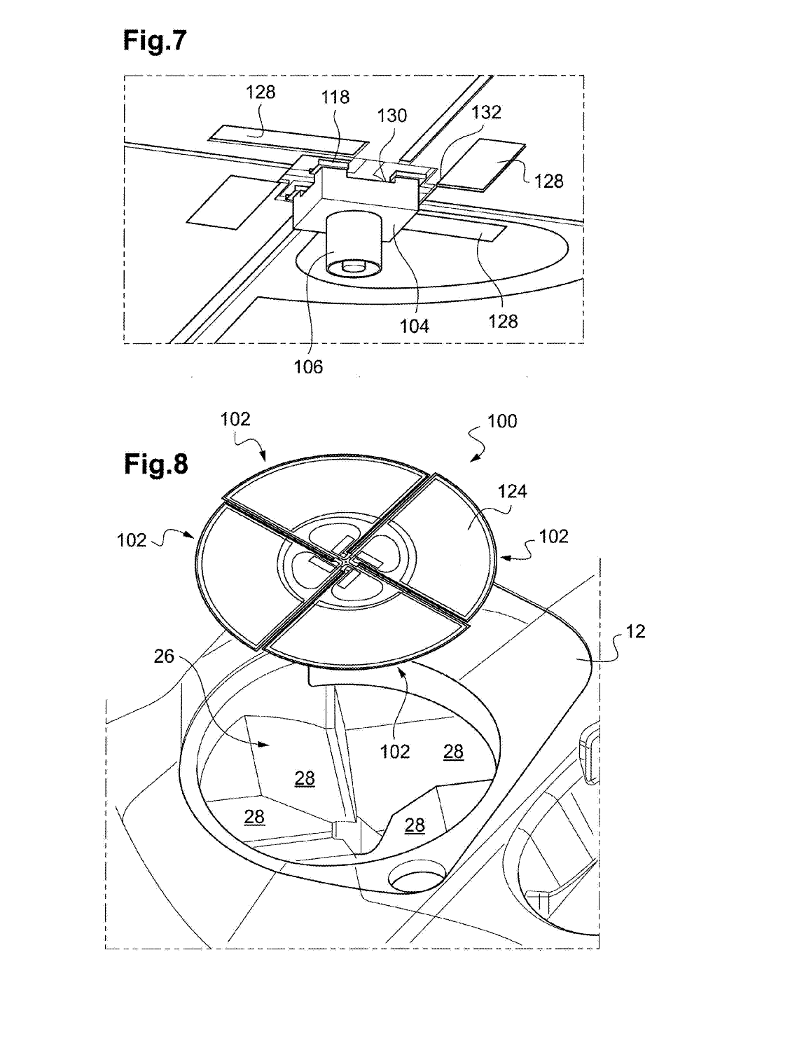

In the vicinity of the central region of the antenna, the four circular sectors are connected to the central portion 130 by narrow bridges of matter 132 (see in particular FIG. 7), acting as a hinge, thanks to the flexibility of the material constituting the support 124. This flexibility may possibly be increased by providing near the central portion 130 additional recesses 128 allowing increasing the deformability of each circular sector in this region.

The module 104 for the coupling and the adaptation to the coaxial cable 106 is welded to the lower face (FIGS. 6 and 7) of the support 124, in the central portion of the latter, and is electrically connected to the conductive tracks forming the two imbricated resonating loops.

Advantageously, a layer of high-permittivity material is bound to the radiating face of each elementary antenna (upper face with the conventions of the figures), so as to adjust the resonance frequencies of the loops back to the desired WiFi frequency bands, which allows reducing the overall size of the antenna with respect to a configuration in which the radiating elements would be devoid of such a layer of high-permittivity material.

It may be used for that purpose a layer of material FR-4, which is a composite of epoxy resin that may be easily laminated to the surface of the flexible PCB support 124.

FIG. 8 illustrates the way the antenna of FIGS. 5 et 6 can be integrated in the drone.

The drone includes for that purpose an antenna housing 26 provided in the fuselage 12 (or in the wings 16, in a neighbour region of the root). This housing 26 includes a relief cavity with non-coplanar inclined planar faces 28, which are the counterparts of the respective inclination planes in which extend the loops of the different elementary antennas of the clover-leaf or skew-planar wheel antenna.

At the time of insertion of the antenna 100 in his housing 26, the circular sectors of each elementary antenna 102 will be deformed in the central region due to the flexibility of the bridges of matter 132 (FIG. 7), so that, by simple insertion, the elementary antennas 102 will each take the desired orientation, characteristic of the clover-leaf or skew planar wheel antenna, simply because of the bearing of the flexible circuit 124 against the inclined planar face 28 that corresponds to it, after deformation of the support 124 in the central region of the antenna.

FIG. 9 is a diagram showing the variation of the parameter S₁₁ describing the electrical behaviour of the antenna of FIGS. 5 to 8, as a function of the emission/reception frequency.

In this figure, the characteristic A illustrates the resonance of the antenna (clover-leaf or skew-planar wheel antenna formed of four elementary antennas 102 in their respective inclined planes), in a configuration including only the conductive tracks etched on the flexible PCB support 124. The characteristic B illustrates the resonance of this same antenna, in a configuration including a coating made of a conventional plastic material, and the characteristic C a configuration with a coating of high-permittivity material such as the FR-4.

As may be observed, the shifting of the resonance frequency provided by the layer of FR-4 allows, with a more reduced size of antenna, shifting the resonance frequency by bring it back to the desired WiFi band, both for the lower band (2.40 GHz-2.4835 GHz) and for the upper band (5.15 GHz-5.85 GHz).

What is claimed is:

1. An antenna with a near-spherical radiation pattern, said antenna being an antenna of the clover-leaf or skew-planar wheel type, comprising:
a plurality of elementary antennas with non-coplanar planar loops extending circumferentially and symmetrically about a main axis of the antenna and remote from this axis, in respective planes inclined with respect to the main axis, these inclined planes forming an angle with respect to a radial plane; and
a module for the coupling and the adaptation of the elementary antennas to a coaxial cable for the power supply of the antenna,
wherein each elementary antenna is formed by tracks of a structure printed on a circuit support extending in said respective inclined plane; and
each elementary antenna comprises two imbricated planar loops, tuned on frequencies comprised in two respective distinct WiFi frequency bands.

2. The antenna of claim 1, wherein the antenna has no conductive element extending in a radial plane and forming a mass plane.

3. The antenna of claim 1, wherein the printed structure of each elementary antenna comprises:
a first rectilinear track and a second rectilinear track that extend radially by forming an angle between each other from a central region of the antenna located in the vicinity of the coupling and adaptation module; and
a first curved track and a second curved track that each extend circularly between the first rectilinear track and the second rectilinear track.

4. The antenna of claim 3, wherein:
the first curved track is an external curved track extending between respective distal ends of the first and the second rectilinear track, and the second curved track is an internal curved track extending between respective median regions of the first and the second rectilinear tracks; and
the first curved track forms with the first and second rectilinear track a loop tuned on a frequency located in a first WiFi band, whereas the second curved track forms with the first and second rectilinear track a loop tuned on a frequency located in a second WiFi band, different from the first WiFi band.

5. The antenna of claim 4, wherein the second curved track is split into two tracks extending parallel to each other and forming two loops respectively tuned on two distinct frequencies of the second WiFi band.

6. The antenna of claim 3, wherein the coupling and adaptation module comprises two terminals with:
a first terminal connecting the proximal ends of the first rectilinear tracks of the respective elementary antennas on one side of the support; and
a second terminal connecting the proximal ends of the second rectilinear tracks of the respective elementary antennas, after passing through the support near said proximal ends.

7. The antenna of claim 1, wherein the angle with respect to a radial plane of said inclined planes in which extend the non-coplanar loops is of at least 20°.

8. The antenna of claim 1, wherein the angle with respect to a radial plane of said inclined planes in which extend the non-coplanar loops is of at most 45°.

9. The antenna of claim 1, wherein the angle with respect to a radial plane of said inclined planes in which extend the non-coplanar loops is comprised between 25° and 30°.

10. The antenna of claim 1, wherein the circuit support is a stiff circuit support made of an epoxy material.

11. The antenna of claim 1, wherein the circuit support is perforated in a zone comprised between the first and the second curved track and/or in a zone comprised between the second curved track and the proximal region of the elementary antenna.

12. The antenna of claim 1, wherein the circuit support is a flexible circuit support.

13. The antenna of claim 12, wherein the flexible circuit support is a pre-notched support with a plurality of radial separating notches radiating between the elementary antennas from a central region of the antenna.

14. The antenna of claim 13, wherein the parts of the flexible circuit support located between the radial separating notches are each connected to the central region by a bridge of matter forming a hinge.

15. The antenna of claim 12, further comprising an additional layer of epoxy material deposited at the surface of the flexible circuit support on the side of the tracks of the printed structure.

16. A drone comprising:
a drone body from which extend laterally two wings and at least two arms;
at least one antenna comprising a plurality of elementary antennas with non-coplanar planar loops extending circumferentially and symmetrically about a main axis of the at least one antenna and remote from this axis, in respective planes inclined with respect to the main axis, these inclined planes forming an angle with respect to a radial plane and a module for the coupling and the adaptation of the elementary antennas to a coaxial cable for the power supply of the at least one antenna, wherein each elementary antenna is formed by tracks of a structure printed on a circuit support extending in said respective inclined plane and each elementary antenna comprises two imbricated planar loops, tuned on frequencies comprised in two respective distinct WiFi frequency bands; and
at least one antenna housing, receiving said antenna.

17. The drone of claim 16, wherein the at least one antenna comprises two antennas arranged symmetrically on either side of the body and incorporated in the thickness of the body or of the wings of the drone.

18. The drone of claim 16, wherein, the circuit support of the elementary antennas is a flexible circuit support, and wherein the antenna housing comprises a conformed hollow cavity comprising a plurality of inclined planar faces, which are the counterparts of the respective inclined planes of the elementary antennas, and against which bear the elementary antennas after deformation of the flexible circuit support.
